(19) United States
(12) Patent Application Publication
(10) Pub. No.: US 2021/0377377 A1
(43) Pub. Date: Dec. 2, 2021

(54) METHOD AND DEVICE FOR SIGNAL TRANSMISSION TO A TERMINAL

(71) Applicant: MOLEX CVS DABENDORF GMBH, Zossen (DE)

(72) Inventors: Frank SCHOLZ, Berlin (DE); Rainer HOLZ, Berlin (DE)

(73) Assignee: MOLEX CVS DABENDORF GMBH, Zossen (DE)

(21) Appl. No.: 16/973,430

(22) PCT Filed: Jun. 25, 2019
(86) PCT No.: PCT/EP2019/066768

§ 371 Date: Dec. 9, 2020

(30) Foreign Application Priority Data
Jun. 28, 2018 (DE) 10 2018 210 544.8

(51) Int. Cl. H04M 1/04; H04B 5/00; H01Q 7/00; H01Q 1/24

(52) U.S. Cl. CPC H04M 1/04; H01Q 1/243; H01Q 7/00; H04B 5/0037

(57) ABSTRACT

A device for charging a portable device is disclosed. The device includes a housing that supports an antenna structure. The housing includes a bottom wall and side walls that define an inner volume and the housing supports a support layer that is deformable and defines a top side of the inner volume. The device includes an antenna structure and can include a filler material that compressibly support the support layer. The antenna structure can be positioned in or on the support layer and can also be positioned in the inner volume.

### RELATED APPLICATIONS

This application is National phase of PCT/EP2019/066768, filed on Jun. 25, 2019, which claims priority from German Application No. 102018210544.8, filed on Jun. 28, 2018 each of which are incorporated herein by reference in their entirely.

### TECHNICAL FIELD

This disclosure relates to a method and a device for signal transmission for data communication to a terminal. The device can in this case in particular be used in a vehicle, preferably a motor vehicle.

### DESCRIPTION OF RELATED ART

Devices for signal transmission to a portable electronic terminal are already known from the prior art.

DE 10 2010 027 620 A1 for example describes an arrangement for wirelessly connecting a wireless device, in particular a mobile telephone, over a wireless connection, in particular to a facility in a motor vehicle or to a stationary wireless device, wherein the arrangement features a supporting surface for supporting the wireless device, wherein the arrangement further features an antenna to establish and maintain the wireless connection of the wireless device. The disclosure further describes that the supporting surface features a rotationally symmetric recess arranged vertically about a rotational axis of the supporting surface, so that a wireless device with a protrusion that engages into the recess maintains a wireless connection to the antenna at different rotational positions about the rotational axis. The document describes that the supporting surface is supported by parts of a housing. This unambiguously shows that the supporting surface is arranged non-deformably.

Mobile phones with a curved display are also known. For example, the website “http://www.areamobile.de/handys/3742-samsung-galaxy-round” describes a smartphone with a display having a concave curvature.

So-called charging pads for mobile phones are also known. For example, the document “Nokia Wireless Charging Pillow by Fatboy DT-901 User Manual, Revision 1.0, 2012, for example downloadable at http://files.eno.de/057643D.pdf” describes a charging pad for wirelessly charging a smartphone. But this document does not disclose data communication between the charging pad and the mobile wireless device.

When mobile terminals with arched or curved surfaces are arranged on the known non-deformable and planar supporting surfaces, this can disadvantageously result in an unstable arrangement that does not ensure a locally fixed storage of the terminal, thus creating the risk of damage. Moreover, this can also result in increased spacing between a transmission and receiving device on the terminal side for data communication, for example an antenna structure, and the device-side transmission and receiving device generally arranged below the supporting surface.

This renders data communication between the terminal and the device more difficult.

This then presents the technical problem of creating a method and a device for signal transmission for data communication to a terminal that in particular also permits a desired transmission quality and a stable storage for terminals with arched or curved surfaces.

### SUMMARY

The technical problem is solved with subject matters having the features illustrated in the Figures and Detailed description.

A device for signal transmission for data communication to a terminal, in particular a mobile or portable terminal, is proposed. The device can in this case be arranged in a vehicle, in particular a motor vehicle. In this case, the device can be used for wireless or cableless signal transmission to the terminal, in particular for signal transmission between vehicle-side devices, such as controllers, and the terminal.

The device, or at least a part of the device, can in this case e.g. be arranged in a center console of the vehicle. Terminals can e.g. be mobile telephones, PDAs (Personal Digital Assistants), audio and video replay devices and microphone units, in particular so-called headsets. But this itemized listing only serves as an example and is not all-inclusive.

The device features at least one transmission and/or receiving means for signal transmission for data communication and/or transmission such as an antenna structure that can be in the form of a coil. Using the antenna structure, signals can then be transmittable to the terminal with power ratings of up to 40 nW, preferably up to 32 nW, and receivable by the terminal with a power rating of up to 3 W, preferably up to 2 W.

The antenna structure is then in particular not used for inductive energy transmission for charging an energy storage device of the terminal.

The antenna structure can in this case be arranged such that signals are receivable and transmittable in a predetermined frequency range. The predetermined frequency range can for example comprise frequencies from 700 MHz (inclusive) up to 2,600 MHz (inclusive). “Receivable” and “transmittable” can in this case mean that the antenna structure is arranged such that it features a return loss for frequencies in the aforementioned predetermined frequency range that is greater than a predetermined value, for example greater than 10 dB. Ideally, the return loss is infinite, such that when in transmission mode, the entire power fed in by the antenna structure is radiated by the transmission means in the predetermined frequency range. The “transmittable” and “receivable” properties can also mean that a coupling factor or a coupling loss of a signal engineering coupling between the antenna structure and a terminal-side antenna structure for signals from the predetermined frequency range is less than a predetermined value, for example less than −8 dB. Ideally, an unattenuated signal engineering coupling should be provided.

It is of course also conceivable that the device features more than one antenna structure for signal transmission for data communication, for example to enable a signal transmission with frequencies different from one another.

The device further has at least one supporting surface for supporting or storing the terminal. The supporting surface can in this case be arranged as, or provided by, a supporting body or a supporting device, which will be explained in detail below. The supporting surface can in this case have a predetermined dimension, for example a minimum width of 160 mm and a minimum length of 90 mm. The minimum width and minimum length values are exemplary and the minimum width and minimum length can of course also have other values.

The supporting surface refers to a surface on which a terminal can be arranged, in particular in the vehicle. In this case, the at least one antenna structure for signal transmission can be arranged relative to the supporting surface such that when the terminal is in the positioned state, a desired signal engineering coupling can be established between the device-side antenna structure and a terminal-side antenna structure.

The supporting surface can in this case be a surface of the supporting element or a supporting layer, in particular an exterior surface. The supporting surface is deformable according to the disclosure. As discussed in detail below, this can mean that a supporting element forming the supporting surface or comprising the supporting surface can also he deformable.

The fact that the supporting surface is deformable can in particular mean that the supporting surface is deformable when acted upon by the weight force of the terminal or when acted upon by a predetermined force that is greater than the weight force of the terminal by a. predetermined metric. In particular, the supporting surface can be deformable when acted upon by a predetermined force that is greater than or equal to a maximum weight force of a terminal.

The supporting surface can be formed as a planar surface in a default position in which the supporting surface is not deformed. In a deformed state, which can for example be created by exerting the aforementioned force, the supporting surface can be curved, or non-planar. The supporting surface can e.g. be concave or convex in relation to an external environment.

The supporting surface can further be deformable such that at least a part of the supporting surface conforms to a shape or an external surface of a positioned terminal, in particular to an arched or curved shape or outer surface. This can in turn mean that the deformed supporting surface can make surface contact to a curved surface of the terminal.

The supporting surface or the supporting element forming the supporting surface or the supporting body can in particular have an undefined (minor) brittleness.

The proposed device provides the ability to advantageously store a terminal, in particular a terminal with an arched or curved shape, in a stable manner, in particular in a vehicle, and while the vehicle is in driving mode. Due to the ability of the supporting surface to conform to the shape of the terminal made possible by the deformability, a size of the contact surface between the supporting surface and the terminal can be advantageously enlarged, which in turn improves a friction-locked and/or shape-locked connection between the device and the terminal. The at least one antenna structure also provides a signal transmission at the desired transmission quality.

The supporting surface is plastically deformable in a further embodiment. The supporting surface can preferably be plastically reversibly deformable. This can mean that the supporting surface can, when acted upon by a force be deformed from a default state, into a deformed state. Without being acted upon by a further force, the supporting surface remains in the deformed state. But by exerting a further force, it is possible to return the supporting surface back to the default state or to deform the supporting surface into a further deformed state. The supporting surface can then also be reversibly deformable, or not permanently deformable.

The supporting surface or a supporting element forming the supporting surface or a supporting body can then have a predetermined ductility or plasticity.

The supporting surface is alternatively elastically deformable. In this case, the supporting surface can also be elastically reversibly deformable. Even for the case of an elastic deformability, the supporting surface can be reversibly or not permanently deformable. In this case, a supporting surface can for example change its shape when acted upon by a force, and return into the default state when the force is no longer exerted, in particular also without being further acted upon by a force. In this case, the supporting surface or a supporting element/supporting body forming the supporting surface can have a predetermined elasticity. The described plastic or elastic deformability advantageously results in good operability of the device according to the disclosure.

In a further embodiment, the supporting surface is formed by a supporting element. Alternatively, a supporting element comprises the supporting surface. Additionally, at least that part of the supporting element is deformable that comprises or forms the supporting surface. The supporting element can in this case be plastically or elastically deformable.

The supporting element can in this case be a supporting body. The supporting element and/or the supporting body can in this case e.g. comprise several layers, in particular an outer layer that can also be referred to as a supporting layer, and at least one inner layer. In this case the outer as well as the inner layer can be deformable, in particular plastically or elastically deformable. The supporting element can in this case comprise a predetermined minimum volume.

The supporting element can in this case be formed as a padded body, or comprise a padded body. The padded body can comprise a cover element that comprises or encloses a padding volume. The supporting surface can in this case be a part of the outer surface of the padding cover. A filler material, for example polyester, can be arranged in the padding volume.

This has the advantageous effect of creating a shape-lock between a terminal and the supporting element for supporting the terminal. By conforming the supporting element to the shape of, and embedding, the terminal, this results in a good safeguard against sliding.

In a preferred embodiment, the supporting surface is formed by a receptacle, wherein the at least one antenna structure for signal transmission is at least partially arranged in or on the supporting layer. The supporting layer can in this case be formed by the aforementioned supporting element or at least a part thereof. The aforementioned outer layer or at least a part thereof can in this case form or provide the supporting layer.

For example, the at least one antenna structure for signal transmission can at least partially or completely be arranged directly on the supporting surface, that is to say an outer surface of the device.

It is however also conceivable that the antenna structure for signal transmission is at least partially or completely arranged on one of the surfaces of the supporting layer opposite the outer surface.

Alternatively, the antenna structure can at least partially or completely be arranged in the supporting layer, that is to say between the outer surface and the surface of the supporting layer opposite said outer surface.

In particular, an antenna structure or a part of the antenna structure that forms the at least one antenna structure can be arranged in or on the supporting layer.

This advantageously minimizes a distance between the device-side antenna structure and a terminal-side antenna structure in the positioned state, because the supporting layer—as discussed above—can in the deformed state conform to an outer shape of the terminal, therefore making direct contact over the surface of the terminal.

This in turn advantageously improves signal transmission, in particular a transmission quality.

In a further embodiment, the at least one antenna structure for signal transmission, in particular a portion of the antenna structure of the at least one antenna structure, is imprinted onto the supporting layer. Alternatively, the at least one antenna structure is woven into the supporting layer. The antenna structure can consist of an electrically conducting material, in particular made of silver or copper, or an alloy. Other materials suited for imprinting or weaving can of course also be used.

This advantageously results in a stable arrangement of the antenna structure on the deformable supporting layer.

In a further embodiment, the device comprises an inductive charging device. The inductive charging device can in this case be used for inductive energy transmission from the device to the terminal. For this purpose, the inductive charging device can generate an electromagnetic alternating field, in particular with a predetermined operating frequency, wherein this electromagnetic alternating field, which can also be referred to as a power transmission field, induces a voltage in a corresponding receiving device of the end user device. Said voltage can in turn be used to charge an energy storage device of the terminal.

The device can in this case in particular comprise a coil structure to generate the power transmission field. The charging device can of course comprise other devices, such as a current and/or voltage selling device, for example a voltage transformer, by which an input current-an input voltage of the aforementioned coil structure can be adjusted to generate the power transmission field.

The inductive charging device can in this case at least partially be arranged in a layer of the supporting element different from the supporting layer. The inductive charging device can for example be at least partially arranged in the aforementioned inner layer.

The inductive charging device can for example be at least partially arranged in the filler material.

This advantageously results in a device that enables both a signal transmission for data communication between the device and the terminal, while at the same time also enabling an energy transmission between the device and the terminal. In this case, up to 5 W or up to 50 W can be transmitted with the power transmission field. Depending on requirements, even higher values can of course also be transmitted.

The operating frequency of the power transmission field generated by the charging device can for example lie in a frequency range from 100 kHz to 10 MHz, and further for example in a frequency range from 105 kHz to 205 kHz.

It is also possible that the device comprises an attenuation structure for attenuating the power transmission field, wherein the attenuation structure can also be at least partially or completely arranged in a layer of the supporting element different from the supporting layer, for example in the inner layer or in the filler material. The attenuation structure can in this case in particular be used to attenuate the electrical field of the power transmission field or the electrical portion of the power transmission field. The attenuation structure can for example be formed and/or arranged such that the electrical field (or the electrical portion) generated by the charging device is attenuated by at least 20 dB, preferably completely attenuated, after propagating through the attenuation structure. The attenuation structure can at the same time be formed such that an attenuation of the magnetic field or the magnetic portion of the electromagnetic field generated by the coil structure is minimized. The attenuation structure can for example be formed and/or arranged such that the magnetic field is attenuated by no more than 1 dB, ideally not attenuated, after propagating through the attenuation structure.

In this case, the attenuation structure can be arranged along a primary propagation direction of the power transmission field between the aforementioned coil structure for generating the power transmission field and the at least one antenna structure, in particular the antenna structure fir signal transmission. As a result the signal transmission is advantageously impaired as little as possible by the electrical field or the electromagnetic portion of the power transmission field.

The attenuation structure can in this case be formed as a circuit board. The circuit board can also have openings, such as slots or openings formed as holes. A dimension, for example a diameter or a width of these openings can be smaller than a predetermined wavelength-dependent dimension.

The dimension can for example be less than or equal to Lambda/100, wherein Lambda represents the wavelength of the signal to be shielded.

But it is also conceivable that the attenuation structure is likewise arranged at least partially or completely in or on the supporting layer. The attenuation structure can in this case also been imprinted onto the supporting layer, or woven into the supporting layer.

It is also conceivable that the attenuation structure forms a mass surface of the aforementioned antenna structure. The attenuation structure can also at least partially be formed in a comb shape.

In a further embodiment, the supporting surface is at least partially or completely ribbed, rubberized, and/or textured, This advantageously results in an increased adhesion and/or sliding friction coefficient between the supporting surface and the terminal, thus further improving a stability of the retention of the device.

In a further embodiment, the supporting surface is deformable such that an inward projecting curvature and/or an outward projecting curvature can be provided. The inward projecting curvature and/or the outward projecting curvature can in this case relate to an exterior environment of the device, The inward projecting curvature and-'or the outward projecting curvature in particular permits the conformance to a concave or a convex shape of the terminal.

A method for signal transmission for data communication to a terminal is also proposed. A device for signal transmission is in this case formed according to any of the aforementioned embodiments. The proposed method is then executable with a device according to any of the aforementioned embodiments. The terminal is also placed onto the supporting surface.

The supporting surface is deformable according to the disclosure.

The terminal can for example be placed onto the supporting surface, wherein the supporting surface is deformed by being acted upon by the weight force of the terminal such that the supporting surface conforms to an outer shape or an outer surface of the terminal. The end user device can alternatively be placed onto the supporting surface and pressed onto the supporting surface with a pressing force greater than a predetermined force, in particular greater than zero. In this case, the weight force and the pressing force act together onto the supporting surface, wherein the sum of the acting pressing force and weight force deforms the supporting surface such that the supporting surface conforms to an outer shape or outer surface of the terminal.

The at least one antenna structure also permits a signal transmission between the device and the terminal.

An inductive energy transmission can also occur between the device and the terminal.

After removing the terminal from the supporting surface, the supporting surface can autonomously or by a corresponding reverse deformation be deformed back into the default state, for example a state with a planar surface. The reverse deformation can e.g. be performed by a user by manually actuating the supporting surface, in particular when a supporting element comprises filler material. The supporting surface can in this case for example be deformed back into the default state by pressing. An autonomous reverse deformation can also be performed alternatively or cumulatively. The supporting element or the supporting surface can for example be formed such that restoring forces act on the supporting surface in the deformed state, said restoring forces deforming the supporting surface back into the non-deformed state. In particular, a corresponding material, such as rubber, can be selected for the supporting surface, or the supporting surface can be formed as a pad filled with gel.

### BRIEF DESCRIPTION OF THE DRAWINGS

The disclosure is explained in detail based on exemplary embodiment provided below, in which:

FIG. 1 illustrates a schematic cross-section of a device according to the disclosure in a non-deformed state,

FIG. 2 illustrates a schematic cross-section of a device according to the disclosure in a first deformed state,

FIG. 3 illustrates a schematic cross-section of a device according to the disclosure in a further deformed state,

FIG. 4 illustrates a schematic cross-section of a supporting layer in a first embodiment,

FIG. 5 illustrates a schematic cross-section of a supporting layer in a second embodiment, and

FIG. 6 illustrates a schematic cross-section of a supporting layer in a third embodiment.

### DETAILED DESCRIPTION

In the following, the same reference symbols identify elements with the same or similar technical features.

FIG. 1 shows a schematic cross-section through a device 1 according, to the disclosure for signal transmission for data communication to a terminal 2. The terminal 2 in this case has a curved shape

The device 1 comprises a housing 3 that comprises or encloses an essentially cuboid-like or cuboid-shaped inner volume 4. The inner volume 4 is in this case enclosed laterally by side walls 5 and on the bottom by a bottom wall 12 of the housing 3. The inner volume 4 is also enclosed on an upper side by a supporting layer 6. The inner volume 4 can be filled with a filler material, for example polyester. The supporting layer 6 and the filler material 7 in this case form a supporting element of the device 1. An outer surface of the supporting layer 6 forms a supporting surface 8 of the device 1. The supporting layer 6 can be formed for example from deformable, in particular reversibly deformable material. The material can for example be an electrically insulating and/or antistatic and/or unprintable and/or water-impermeable and/or low-odor and/or light-resistant and/or easily-cleaned and/or temperature-resistant and/or vibration-resistant material. The material can also be sliding-inhibiting, such as a thermoplastic elastomer with a Shore hardness of e.g. 70. The material can be (electro)-plateable, particular with copper or silver.

The supporting surface preferably has a low thickness, wherein the supporting layer preferably continues to be durable in spite of the low thickness.

The material is also preferably suited to contain or enclose a gel-filled volume. The material can also be provided in film form and processed as a film, The material is preferably anti-allergic. The material should also be moisture-resistant and hydrophobic, The material should also have a low or no shape memory effect.

The sum total of the supporting layer 6 and filler material 7 is in this case at least deformable in the area of the supporting layer 6.

The terminal 2 that is placed onto the supporting surface 8 can then sink into the inner volume 4. wherein the supporting layer 6 together with the supporting surface 8 is deformed by the weight force exerted by the terminal 2. The terminal 2 can also be pressed into the inner volume 4, wherein the supporting layer 6 together with the supporting surface 8 is deformed by the exerted sum of the weight force of the terminal 2 and the pressing force for example exerted by a user.

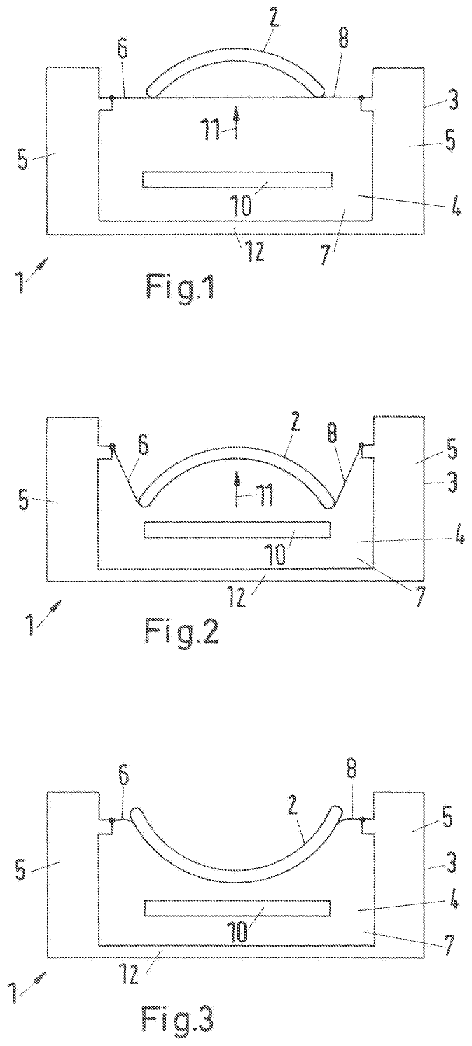

In both cases, a shape of the supporting surface 8 and a shape of the supporting layer 6 can conform to the outer shape of the terminal 2. This is shown in FIGS. 2 and 3.

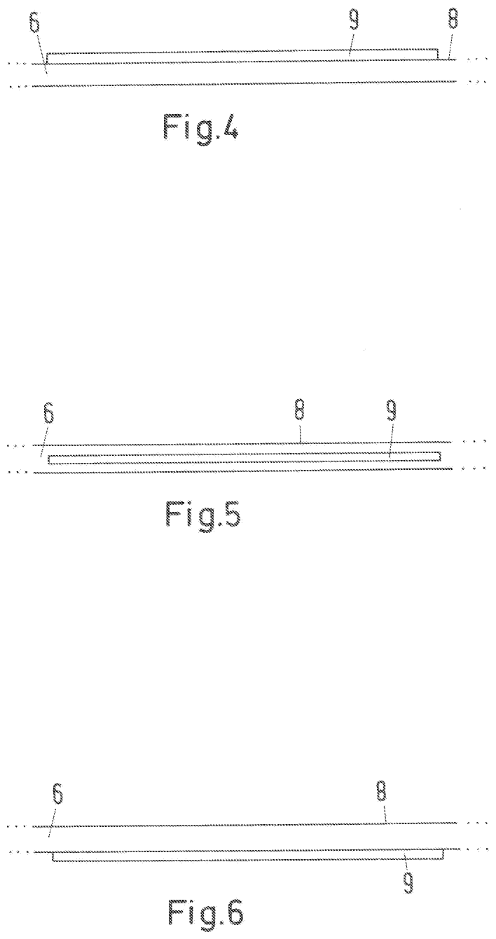

FIG. 1 does not show an antenna structure 9 for signal transmission (see e.g. FIG. 4) to the terminal 2. Said antenna structure 9 can in this case be arranged in or on the supporting layer 6.

The figures further show that the device 1 comprises a coil structure 10 of an inductive charging device, wherein the coil structure 10 can be used to generate a power transmission field whose primary propagation direction is represented by an arrow 11. The coil structure 10 is in this case arranged in the inner volume 4, in particular in the filler material 7 and below the supporting layer 6, wherein the primary propagation direction in FIG. 1 is oriented from the bottom toward the top.

FIG. 1 shows the device 1, in particular the supporting layer 6 or the supporting surface 8 in a non-deformed default state, wherein the default state provides a planar supporting surface 6.

FIG. 2 shows the device 1 shown in FIG. 1 in a first deformed state. In this case, the supporting layer 6 and a partial area of the supporting element consisting of the filler material 7 and the supporting layer 6 is deformed by being acted upon by the weight force of the terminal 2 and by any additionally exerted pressing force by which the terminal 2 is pressed against the supporting surface 8.

FIG. 2 shows that the supporting layer 6 is deformed such that the supporting surface 8 contacts the surface of the terminal 2, the surface having a concave curvature in relation to the supporting surface 8. In contrast to the non-deformed state, partial sections of the terminal 2 now project into the inner volume 4, which however continues to be enclosed by the housing 3 and the supporting layer 6.

FIG. 3 shows the device 1 shown in FIG. 1 in a further deformed state. FIG. 3 in this case shows that the supporting layer 6 is deformed by being acted upon by the weight force of the terminal 2 and by any additionally exerted pressing force such that the supporting surface 8 contacts the outer surface of the terminal 2, the outer surface having a convex curvature in relation to the supporting surface 8.

FIGS. 2 and 3 show that a size of the contact surface between the supporting surface 8 and the outer surface of the terminal 2 in the deformed states is in each case larger than in the non-deformed state shown in FIG. 1. The larger contact surface without limitation results in a greater adhesion and/or sliding friction between the terminal 2 and the supporting layer 6 and/or the supporting surface 8. The ability to deform the supporting surface 8 also enables an at least partial shape lock between the terminal 2 and the device 1. Both advantageously increase the stability of an arrangement of the terminal 2 on the supporting surface 8.

FIG. 4 shows a schematic cross-section through a supporting layer 6 in a first embodiment. An antenna structure 9 used for signal transmission for data communication to the terminal 2 (see FIG. 1) is in this case arranged on the supporting surface 8, which is formed by the supporting layer 6. The supporting surface 8 in this case forms an outer surface of the supporting layer. The antenna structure 9 can in this case for example be imprinted or glued onto the supporting surface 8

FIG. 5 shows a schematic cross-section through a supporting layer in a second embodiment. The antenna structure 9 is in this case arranged in the supporting layer 6. The antenna structure 9 can for example be woven into the supporting layer 6.

FIG. 6 shows a schematic cross-section through a supporting layer 6 in a further embodiment. The antenna structure 9 is in this case arranged on a surface of the supporting layer 6 opposite the supporting surface 8. The surface of the supporting layer 6 opposite the supporting surface can in this case be an inner surface of the supporting layer 6.

The disclosure provided herein describes features in terms of preferred and exemplary embodiments thereof. Numerous other embodiments, modifications and variations within the scope and spirit of the appended claims will occur to persons of ordinary skill in the art from a review of this disclosure.

1. A device for signal transmission to a terminal, comprising:
a housing with a bottom wall, side walls and a supporting layer, the housing defining an inner volume;
an antenna structure supported by the housing, wherein the wherein the supporting layer is configured to deform when the terminal is pressed thereon.

2. The device of claim 1, wherein the supporting layer is elastically deformable.

3. The device of claim 2, wherein the supporting layer is supported by a filler material.

4. The device of claim 3, wherein the supporting layer at least partially encloses the filler material.

5. The device of claim 4, wherein the antenna structure is at least partially arranged on the supporting layer.

6. The device of claim 4, wherein the antenna structure is at least partial arranged in the supporting layer.

7. The device of claim 1, wherein the antenna structure is a coil configured to inductively charge the terminal.

8. The device of claim 1, wherein the supporting layer is configured to increase sliding friction between the terminal positioned thereon and the supporting layer.

9. The device of claim 1, wherein the supporting layer is configured to be deformed to match a curved surface of a terminal pressed against the supporting layer.

10. The device of claim 1, wherein the antenna structure is positioned in the inner volume.

11. The device of claim 10, wherein the inner volume includes a filler material and the filler material is positioned between the antenna structure and the support layer.

12. The device of claim 11, wherein the filler material is compressible.
